(19) United States
(12) Patent Application Publication
(10) Pub. No.: US 2020/0114438 A1
(43) Pub. Date: Apr. 16, 2020

(54) SHEARING DEVICE AND ALUMINUM SHEARING METHOD USING THE SAME

(71) Applicants: Hyundai Motor Company, Seoul (KR); KIA Motors Corporation, Seoul (KR)

(72) Inventor: YOUN IL JUNG, Seoul (KR)

(73) Assignees: Hyundai Motor Company; KIA Motors Corporation

(21) Appl. No.: 16/294,348

(22) Filed: Mar. 6, 2019

(30) Foreign Application Priority Data
Oct. 11, 2018 (KR) 10-2018-0121128

(51) Int. Cl. B23D 36/00; B23D 15/04

(52) U.S. Cl. CPC B23D 36/0016; B23D 15/04

(57) ABSTRACT

A shearing device and a method for an aluminum material are provided. The shearing device includes an upper pad die, a lower pad die, a first electrode provided on each of the upper pad die and the lower pad die, a heating device provided on the first portion of the upper pad die and the lower pad die, respectively as surface parts; and a shearing die provided on the upper pad die to move up and down with respect to a surface to which the aluminum material is discharged and including a second electrode. In addition, the shearing method for the aluminum material is provided for reducing chips generated during the shearing process.

### CROSS-REFERENCE TO RELATED APPLICATION

This application claims priority to and the benefit of Korean Patent Application No. 10-2018-0121128, filed on Oct. 11, 2018, which is incorporated herein by reference in its entirety.

### FIELD

The present disclosure relates to a shearing device and an aluminum shearing method using the same.

### BACKGROUND

The Statements in this section merely provide background information related to the present disclosure and may not constitute prior art.

General press work for machining parts by applying an aluminum sheet is composed of a drawing operation in which dies are mounted on a press and is vertically pressed to form a predetermined shape, a trimming operation in which a portion that is not needed in a finished product is cut, a flanging operation in which an additional shape is formed, and a piercing operation in which a hole and the like are machined.

The above described operations are collectively referred to as a stamping process, and a panel is completed through an average of four operations, such as forming, cutting, bending, and hole machining. The trimming is an operation for cutting out undesired portions in a plastic processed panel that is formed in a shape corresponding to product design data from an aluminum panel through a drawing operation, that is, the most important operation that determines the quality of a sheared surface of a finished product.

A stamping device for trimming operates such that a lower die having an outer shape of a bottom surface of a product is mounted on a bolster provided at a lower side of the stamping device and an upper die having an outer shape of a top surface of the product is mounted on a slide, that is, a press body provided at an upper side of the stamping device, and in a state in which the product subjected to the drawing is inserted between the upper die and the lower die, a periphery of the drawing panel is pressed to come into a close contact state, and undesired portions are removed from the drawing panel through a shearing operation.

The conventional dies used for the trimming operation is largely composed of a shear blade, an upper pad, and a lower pad. In addition, the overall process of the trimming operation is performed in the sequence of operation (A) in which a drawing panel formed in a certain shape is mounted on an upper end surface of the lower pad, operation (B) in which the upper pad is lowered so that a periphery of the drawing panel is fixed by the upper pad and the lower pad, and operation (C) in which the shear blade is lowered so that undesired portions are sheared to be removed. Then, the drawing panel is subjected to the flanging, and the piercing operations, so that a finished product is manufactured.

During trimming of an aluminum, we have discovered that large amount of chips are generated in a sheared surface compared to when a steel plate is trimmed. Since the aluminum has an elongation less than that of a steel plate, and has a small local deformation (elongation after necking) in the entire plastic deformation region, a brittle fracture occurs due to lack of ductility during shearing, and in this process, a breaking zone is increased in a sheared surface, thus causing large amount of chips. In general, large amount of chips are generated when a breaking zone is larger than a shear zone during shearing of a metal sheet.

We have discovered that the large amount of chips generated during the trimming operation remain inside the dies, and when a next drawing panel is mounted on the trim die, the chips are moved to an upper surface of the panel by an airflow and are attached to the surface of the panel, and at a subsequent operation, e.g., flanging and piercing operations, it causes a quality defect on the surface of the panel, such as, stabbing.

The above information disclosed in this Background section is only for enhancement of understanding of the background of the present disclosure, and therefore it may contain information that does not form the prior art that is already known to a person of ordinary skill in the art.

### SUMMARY

The present disclosure provides a shearing device and method for an aluminum material.

According to an aspect of the present disclosure, the shearing device includes an upper pad die, a lower pad die, a first electrode provided on at least one of the upper pad die and the lower pad die, a heating device provided on at least one of a first portion of the upper pad die and the lower pad die, and a shearing die provided on the upper pad die to move up and down with respect to a surface to which the aluminum material is discharged. In addition, the shearing die further includes a second electrode.

The shearing device may further includes a power control device configured to supply the first electrode and the second electrode with direct current when the shearing die comes into contact with the aluminum material, and a power supply device configured to supply the heating device or the power control device with alternating current.

The first electrode and the second electrode may be provided to have polarities opposite to each other. The first electrode and the second electrode may be coated with insulators.

The shearing device may further include a cooling channel provided inside the upper pad die and the lower pad die, respectively. The shearing device may further include a cooling compressor configured to supply the cooling channel with a refrigerant.

The first portion of each of the upper pad die and the lower pad die may be formed of cemented carbide-M series including cemented carbide-M series (WC+TiC+TaC+Co alloys).

According to another aspect of the present disclosure, the shearing method for an aluminum panel includes steps of lowering an upper pad die for a first period of time, heating the aluminum panel for a second period of time, supplying current while lowering a shearing die to remove undesired portions of the aluminum panel for a third period of time, and lifting the shearing die for a fourth period of time.

The aluminum panel may have a temperature in a range of 200° C. to 300° C. The second period of time may be equal to or greater than eight seconds. The current density of the supplied current may be in a range of 70 A/mm² to 90 A/mm². The third period of time may be in a range of 0.5 seconds to 0.8 seconds.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a graph showing a correlation between the elongation and the strength of an aluminum material according to temperatures in a tensile test;

FIG. 2 is a graph showing a correlation between the elongation and the strength of an aluminum material according to applied current density in an electro-plastic tensile test;

FIG. 3 is a diagram showing an oriental distribution function (ODF) map of an aluminum material according to applied current density in an electro-plastic tensile test;

FIG. 4 is a perspective view illustrating a shearing device according to an exemplary form of the present disclosure;

FIG. 5 is a block diagram illustrating a shearing device according to the exemplary form of the present disclosure;

FIG. 6 is a cross-sectional view illustrating a structure of electrodes according to the exemplary form of the present disclosure;

FIG. 7 is a diagram for describing an operating mechanism of a shearing device according to the exemplary form of the present disclosure;

FIG. 8 is a photograph showing a sheared surface of an aluminum material when a conventional trimming process is performed; and

FIG. 9 is a photograph showing a sheared surface of an aluminum material when a trimming process according to the exemplary form of the present disclosure is performed.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Based on the need to secure ductility of an aluminum material and reduce a shearing load to suppress generation of chips during a stamping process of an aluminum material, specifically, a trimming process, the inventors of the present disclosure have conducted experiments and obtained a condition for aluminum shearing capable of suppressing generation of chips from an aluminum material, by applying heat and supplying current to the aluminum material

Hereinafter, a shearing device and an aluminum shearing method according to an exemplary form of the present disclosure will be described in detail with reference to the accompanying drawings.

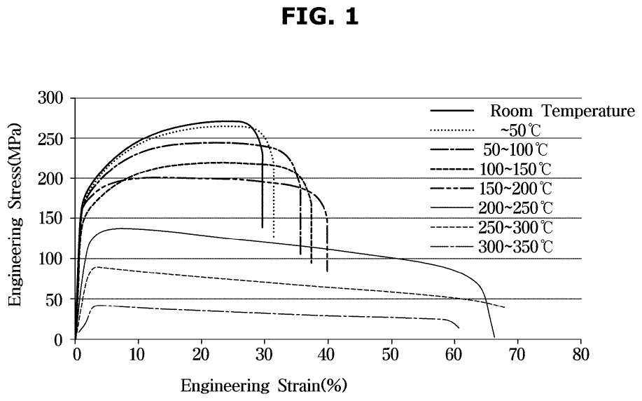

FIG. 1 is a graph showing a correlation between the elongation and the strength of an aluminum material according to temperatures in a tensile test.

Table 1 shows the tensile strength (MPa) and the elongation (%) of an aluminum material according to the temperatures to derive the optimum heating condition.

TABLE 1

| | Tensile strength (MPa) | Elongation (%) |
|---|---|---|
| Room temperature | 271.36 | 29.55 |
| ~50° C. | 265.09 | 31.34 |
| 50~100° C. | 224.49 | 35.58 |
| 100~150° C. | 220.04 | 37.36 |
| 150~200° C. | 201.11 | 39.84 |
| 200~250° C. | 137.59 | 66.27 |
| 250~300° C. | 89.10 | 67.87 |
| 300~350° C. | 41.58 | 60.65 |

Referring to FIG. 1, the tensile test was performed on an aluminum material (A6014-t4, 1.1 mm) at different temperatures, and it can be seen that the strength decreases and the elongation rate increases as the temperature increases from the room temperature to 300° C. However, when the temperature increases to 350° C., both the strength and the elongation tends to decrease. In consideration of such a result, the heating temperature of the aluminum material may be set to a range of 50 to 300° C.

In an implementation, the heating temperature of an aluminum material may be set to a range of 200 to 300° C. Referring to Table 1, it can be seen that the elongation value (%) is significantly increased in a range of 200 to 250° C. compared to a range of 150 to 200° C. Accordingly, it can be seen that the aluminum material needs to be heated in a range of 200 to 300° C. to increase the ductility of the aluminum material.

Generally, when the breaking zone is larger than the shear zone during shearing of a metal sheet, large amount of chips are generated. It is generally known that in order to increase the shear zone, the deformation load needs to be reduced.

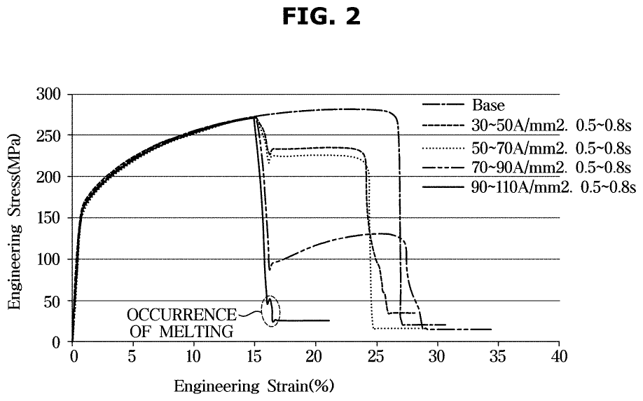

FIG. 2 is a graph showing a correlation between the elongation and the strength of an aluminum material according to applied current density in an electro-plastic tensile test.

Referring to FIG. 2, it can be seen that reduction in load momentarily occurs when current is applied during uniaxial tensile deformation of an aluminum material (A6014-t4, 1.1 mm), that is, a weight reduction effect.

In order to derive the optimum conduction condition, the time for applying a current is fixed to 0.5 to 0.8 seconds in consideration of a general time for a shearing blade to shear an aluminum material during a trimming process, and the tensile test is performed while changing the applied current density.

Table 2 shows the load (MPa) of the aluminum material according to the applied current density. Since the amount of current to be applied varies depending on the thickness of an aluminum sheet, the present disclosure has introduced the concept of a current density that is independent of the thickness (unit: A/mm²).

TABLE 2

| | Load | Note |
|---|---|---|
| Base | 270.90 | |
| 30~50 A/mm² | 226.56 | |
| 50~70 A/mm² | 216.57 | |
| 70~90 A/mm² | 88.47 | |
| 90~110 A/mm² | 25.43 | Occurrence of aluminum |
| | | melting |

Referring to Table 2 and FIG. 2, in a range of 30 to 90 A/mm² of current density, the current density increases, the load decreases. However, as shown in FIG. 2, in a range of 90 to 110 A/mm², the aluminum material melts due to resistance heat. Accordingly, it can be seen that in order to reduce a load acting on an aluminum material, the current needs to be applied to the aluminum material in a range of 30 to 90 A/mm².

Generally, aluminum, as a polycrystalline material, is composed of individual crystal grains having different orientations. When observed by a scanning electron microscope (SEM), the individual crystal grains have different diffraction patterns. Electron Backscatter Diffraction (EBSD) is a representation of a diffraction pattern calculated by specific software and expressed in coordinates.

In order to determine the cause of reduction in load during deformation of an aluminum material, the microstructure of the aluminum material is measured using the EBSD.

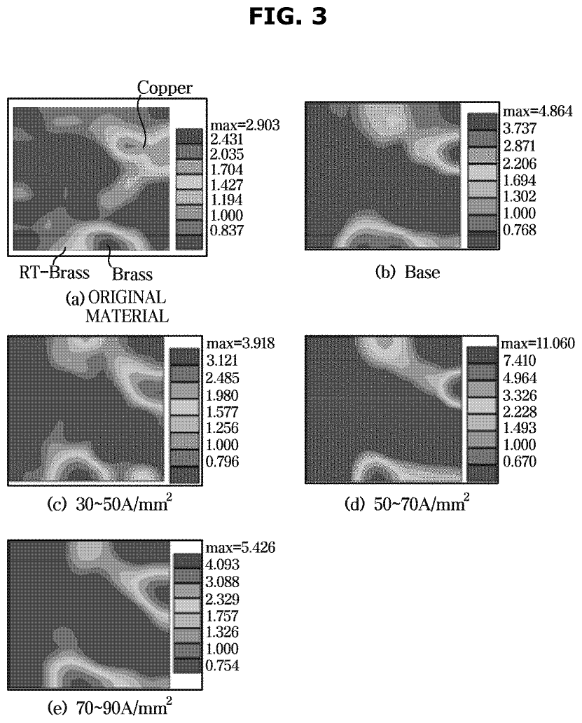

FIG. 3 shows an oriental distribution function (ODF) map of an aluminum material according to applied current density in an electro-plastic tensile test, in which the fractions of rotated brass, brass and copper textures are calculated.

Referring to FIG. 3, in the coordinates represented on the EBSD, specific regions have unique names of the textures, such as Copper, Brass, and RT-Brass.

Meanwhile, the number of crystal grains having an RT-Brass orientation in the EBSD measurement region may be quantified as a relative value (without unit). For example, the number of the crystal grains is measured as a value of 3067 in FIG. 3(a), the number of the crystal grains is measured as a value of 1775 in FIG. 3(b), the number of the crystal grains is measured as a value of 2194 in FIG. 3(c), the number of the crystal grains is measured as a value of 2302 in FIG. 3(d), and the number of the crystal grains is measured as a value of 2608 in FIG. 3(e).

According to the result of EBSD measurement, it can be seen that the fraction of the rotated brass was about 10% when the tensile test was conducted without applying current, but the fraction of the rotated brass was 20% to 40% when the tensile test was conducted with current applied. Therefore, it is determined that the reduction in load during the electro-plastic tensile test of the aluminum material is caused by the growth of Rotated Brass texture.

Meanwhile, Taylor Factor (M) is a value representing the degree to which a slip system is moved to generate a predetermined amount of deformation. Rotated Brass has an M value of 3.03, Brass has an M value of 3.57, and Copper has an M value of 3.43. A lower M value indicates less movement of the slip system (dislocation).

When Rotated Brass texture grows at an inside of an aluminum material, a slip system movement for predetermined deformation occurs to a small degree. That is, an increase in relative dislocation density is small, and thus a load for deformation is reduced.

Hereinafter, a shearing device according to an exemplary form of the present disclosure for suppressing generation of chips from an aluminum material by simultaneously applying heat and current to an aluminum material will be described.

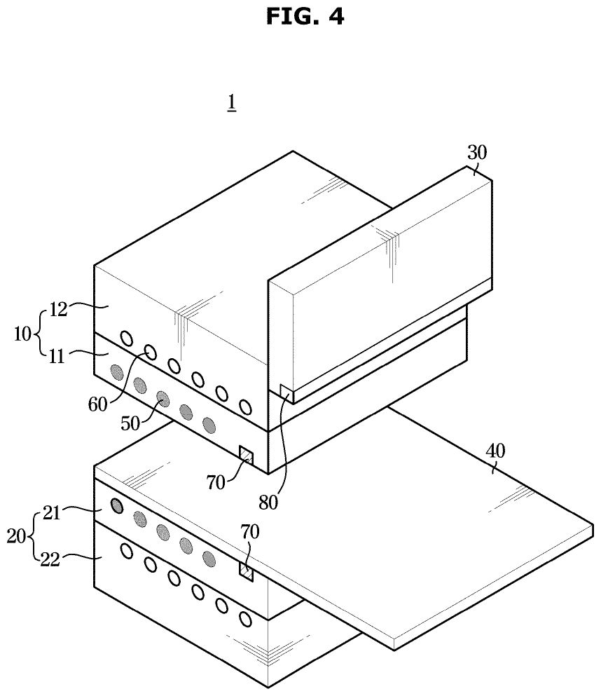

FIG. 4 is a perspective view illustrating the shearing device according to the exemplary form of the present disclosure.

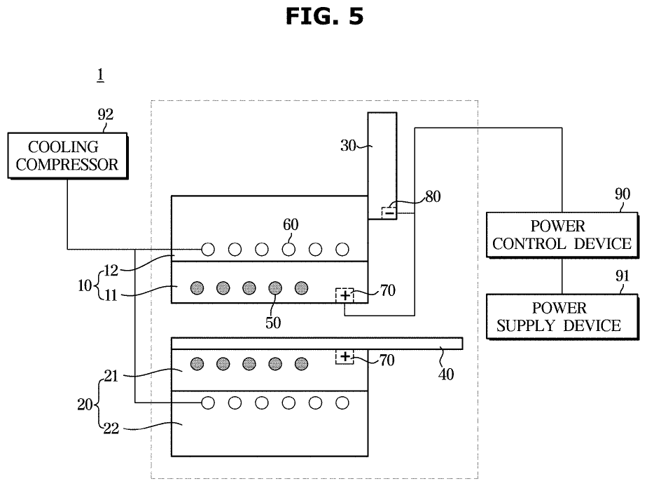

FIG. 5 is a block diagram illustrating the shearing device according to the exemplary form of the present disclosure.

Referring to FIGS. 4 to 5, the shearing device 1 according to the exemplary form of the present disclosure includes an upper pad die 10 configured to pad an aluminum material 40 and including a first electrode 70, a lower pad die 20 configured to pad the aluminum material 40, a heating device 50 provided on first portion of the upper pad die 10 and the lower pad die 20, a shearing die 30 provided on the upper pad die 10 and configured to move up and down with respect to a surface to which the aluminum material 40 is discharged, and including a second electrode 80 and a power control device 90 configured to supply the first electrode 70 and the second electrode 80 with direct current when the shearing die 30 comes into contact with the aluminum material 40.

The upper pad die 10 serves to fix the aluminum material 40, which has been subjected to drawing, before a shearing operation is performed on the aluminum material 40. The upper pad die 10 is located above the aluminum material 40 and is moved up and down to press an upper side of the aluminum material 40.

In addition, the upper pad die 10 may include the first electrode 70. In detail, the first electrode 70 may be provided at the front portion of the upper pad die 10. In addition, the first electrode 70 may be provided at the front portion of the lower pad die 20 as will be described below. Details of the first electrode 70 will be described below.

The lower pad die 20 serves to fix the aluminum material 40, which has been subjected to drawing, before the shearing operation is performed on the aluminum material 40. The lower pad die 20 faces the upper pad die 10 and is positioned below the aluminum material 40. The lower pad die 20 supports a lower side of the aluminum material 40 when the upper pad die 10 is lowered.

The shearing device 1 may include the heating device 50 for supplying heat to the aluminum material 40. Referring to FIG. 4, the heating device 50 may be provided on a lower side of the upper pad die 10 or on an upper side of the lower pad die 20. The heating device 50 is preferably provided on the lower side of the upper pad die 10 and the upper side of the lower pad die 20 at the same time. In this case, it is efficient to reach the target heating temperature of the aluminum material 40. Hereinafter, the lower side of the upper pad die 10 or the upper side of the lower pad die 20 may be referred to as a first portion 11 and 21, respectively as surface parts.

The heating device 50 provided on the first portion 11 and 21 may have various shapes, sizes, and numbers as long as it can enhance the thermal efficiency of heat transferred to the aluminum material 40.

When current is supplied from a power supply device 91 which will be described below, to the heating device 50 in the process of fixing the aluminum material 40 by the upper and lower pad dies 10 and 20, heat is generated from each of the first portions 11 and 21, respectively. At this time, the temperatures of the upper and lower pad dies 10 and 20 may be kept in a range of 470 to 490° C. Accordingly, the aluminum material 40 may be heated in a range of 200 to 300° C. In an implementation, the temperatures of the aluminum material 40 may be kept in a range of 200 to 250° C.

The first portions 11 and 21 are not only heated, but also is supplied with a consistent load during a trimming process, thus desiring heat resistance and strength. Accordingly, the first portions 11 and 21 may be formed of cemented carbide-M series (WC+TiC+TaC+Co). Here, + means that each element can be selectively included. The cemented carbide-M series is not limited to a specific type, and may be various implemented as long as it can secure heat resistance.

Meanwhile, a remaining portion of the upper pad die 10 and the lower pad die 20 except for the first portions 11 and 21, that is, an upper side of the upper pad die 10 and a lower side of the lower pad die 20, which will be referred to a second portion 12 and 22, respectively, may be formed of a general alloy tool steel (SKD11) for the sake of convenience in processing.

SKD11 is a high carbon (C) and high chromium (Cr) steel having a carbon (C) content of about 1.4 to 1.6 wt %, a silicon (Si) content of less than about 0.40 wt %, a manganese (Mn) content of less than about 0.60 wt %, a phosphorus content less than about 0.030 w % a sulfur (S) content of about 0.030 wt %, a chromium (Cr) content of about 11.0 to 13.0 w %, a molybdenum (Mo) content of about 11.0 to 13.0 w %, a nickel (Ni) content of about 0.80 to 1.20 w %, a vanadium(V) content of about 0.20 to 0.50 wt %, and the like, and is also a steel generally used. The second portions 12 and 22 may be implemented without limitation to a specific type as long as it can secure the strength.

The shearing device 1 according to the exemplary form of the present disclosure may include a cooling channel 60 through which a refrigerant passes. The refrigerant may be supplied by a cooling compressor 92, which will be described later.

The heat supplied by the heating device 50 may cause thermal deformation to the upper pad die 10 and the lower pad die 20, and the cooling channel 60 serves to inhibit heat from being accumulated or diffused.

The cooling channel 60 may be provided at a boundary between the first portions 11 and 21 and the second portions 12 and 22 in each of the upper pad die 10 and the lower pad die 20. Accordingly, the second portions 12 and 22 are inhibited from being deformed by heat.

The cooling channels 60 provided at the boundary between the first portion 11 and 21 and the second portion 12 and 22 may have various shapes, sizes, and numbers similar to the heating device 50.

The shearing die 30 serves to remove an undesired outer portion of the aluminum material 40, which has been subjected to drawing, through shearing. The shearing die 30 may be provided on the upper pad die 10 and configured to vertically move with respect to a surface to which the aluminum material 40 is discharged.

The shearing die 30 is subject to a consistent load during trimming. Accordingly, the shearing die 30 may be formed of an alloy tool steel (SKD11) to securing the strength. The shearing die 30 may be variously implemented without being limited, as long as it can secure the strength.

Referring to FIGS. 4 and 5, the second electrode 80 may be provided at a side of the front portion of the shearing die 30 to momentarily apply current at a time of shearing. The second electrode 80 may form a circuit with the first electrode 70 included in the upper pad die 10 and the aluminum material 40 at a time of shearing in which the shearing die 30 comes into contact with the aluminum material 40. Alternatively, the second electrode 80 may form a circuit with the first electrode 70 included in the lower pad die 20 and the aluminum material 40.

In detail, the second electrode 80 may be provided at an outer side of the front portion (a lower right side) of the shearing die 30. When the second electrode 80 is provided at an inner side of the front portion (a lower left side), the second electrode 80 may be deformed at a time of shearing since copper forming the second electrode 80 has a low strength. According to the present disclosure, the second electrode 80 is provided at the outer side of the front portion of the shearing die 30 so that deformation of the second electrode 80 is reduced when the aluminum material 40 is sheared.

At this time, the polarities of the first electrode 70 and the second electrode 80 are opposite to each other. For example, when the first electrode 70 is a positive (+) pole, the second electrode 80 is a negative (−) pole, and when the first electrode 70 is a negative (−) pole, the second electrode 80 is a positive (+) pole. As such, the aluminum material 40 is supplied with current so that the above described texture control is performed and thus a load acting on the aluminum material 40 is reduced.

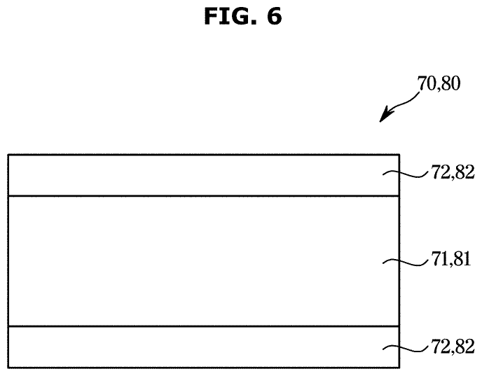

FIG. 6 is a cross-sectional view illustrating a structure of electrodes according to an exemplary form of the present disclosure.

Since the first electrode 70 and the second electrode 80 are provided inside the upper pad die 10 and the shearing die 30, which are formed of metal, respectively, the current may flow to the dies and the press equipment at the time of the shearing.

Accordingly, the first electrode 70 and the second electrode 80 may be formed in an insulating structure. In detail, a copper may be used as electrode materials 71 and 81, and insulator materials 72 and 82 may cover the copper electrodes. Bakelite may be used as the insulator materials 72 and 82.

By using the insulating structure, current is inhibited from flowing to the dies and the press equipment when current is applied, thereby securing the safety of the shearing device.

Referring back to FIG. 5, the shearing device 1 may include the power control device 90. The power control device 90 is configured to supply direct current (DC) to the first electrode 70 and the second electrode 80 provided in the upper pad die 10 and the shearing die 30, and converts alternating current supplied from the power supply device 91 into direct current.

In detail, at a time of shearing in which the shearing die 30 comes into contact with the aluminum material 40, the power control device 90 may supply direct current to the first electrode 70 and the second electrode 80 such that current flow to a shearing portion of the aluminum material 40.

Referring to FIG. 5, the shearing device 1 may include the power supply device 91. The power supply device 91 is connected to an external commercial AC power source (not shown) through a wired power cable. The power supply device 91 transfers the power supplied from the commercial AC power source to the power control device 90.

In addition, the power supply device 91 may supply power to the heating device 50 such that the aluminum material 40 is heated.

Referring to FIG. 5, the shearing device 1 may include a cooling compressor 92. The cooling compressor 92 supplies low temperature refrigerant to the cooling channel 60.

Hereinafter, an aluminum shearing method according to an exemplary form of the present disclosure will be described.

The aluminum shearing method includes steps of lowering an upper pad die for a first period of time, heating an aluminum panel for a second period of time longer than the first period of time, supplying a current for lowering a shearing die for a third period of time shorter than the first period of time, and lifting the shearing die for a fourth period of time longer than the first period of time and shorter than the second period of time.

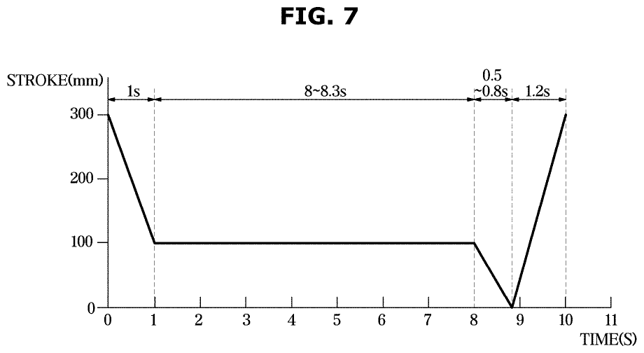

FIG. 7 is a diagram for describing an operating mechanism of a shearing device according to an exemplary form of the present disclosure. Referring to FIG. 7, the stroke in the vertical axis represents a displacement of a die from a position at which the press equipment is completely lowered, the position set to a reference position of 0 mm.

First, the aluminum material subjected to the drawing process is mounted on the upper side of the lower pad die.

In the lowering of the upper pad die, the upper pad die is lowered and a force having the same magnitude as that of a pressure of the upper pad die is applied in a direction toward a die surface of the lower pad die by a press cushion pin (not shown) so that a periphery of the aluminum material is firmly fixed. The lowering of the upper pad die takes about one second, which is referred as the first period of time.

In the heating of the aluminum panel, the temperature of the aluminum material is raised by the upper and lower pad dies, which are kept in the temperature range of 470 to 490° C. by receiving heat from the heating device.

As described above, in order to increase ductility of the aluminum material, heating in a temperature range of 200 to 300° C. is desired.

Referring back to FIG. 1, it can be seen that when the temperature of the aluminum material increases from a range of 200 to 250° C. to a range 250 to 300° C., the increase in ductility is not great. Accordingly, the final target temperature of the aluminum material may be set to the range of 200 to 250° C. in consideration of the temperature rise time such that the productivity of the process is secured.

Meanwhile, the temperature of 490° C. corresponds to a solution annealing temperature of an aluminum material. The temperature of the upper and lower pad dies are set to a range of 470 to 490° C. in consideration of a great change in material properties occurring above the range of 470 to 490° C. and the efficiency of the shearing process. In this case, the cooling channel 60, through which a low-temperature refrigerant passes, inhibits heat from being accumulated, so that the temperature of the upper and lower pad dies may be kept in a range of 470 to 490° C.

In this case, the time taken for the temperature of the aluminum material to be raised to the range of 200 to 250° C. by a thermal conduction of the upper and lower pad dies of 470 to 490° C. is about 8 seconds, specifically, 8 seconds to 8.3 seconds. This is referred to as the second period of time.

In the supplying of current while lowering the shearing die, the shearing die is lowered to remove undesired portions from the heated aluminum material. Typically, the shearing process takes about 0.5 to 0.8 seconds.

At a time of shearing when the shearing die comes into contact with the aluminum material, the second electrode further comes into contact with the aluminum material to form a circuit with the first electrode and the aluminum material, so that current flows through the shearing portion of the aluminum material.

As described above, in order to reduce the load desired for deforming (shearing) the aluminum material, a current of 70 to 90 A/mm² needs to be applied for 0.5 to 0.8 seconds, the power control device may apply current of 70 to 90 A/mm² to the first electrode and the second electrode. The application of the current takes 0.5 to 0.8 seconds. This is referred to as the third period of time.

In the lifting of the die after the completion of the shearing process, the upper pad die and the shearing die are lifted to the original position before performing the shearing process. The lifting of the die takes about 1.2 seconds. This is referred to as the fourth period of time.

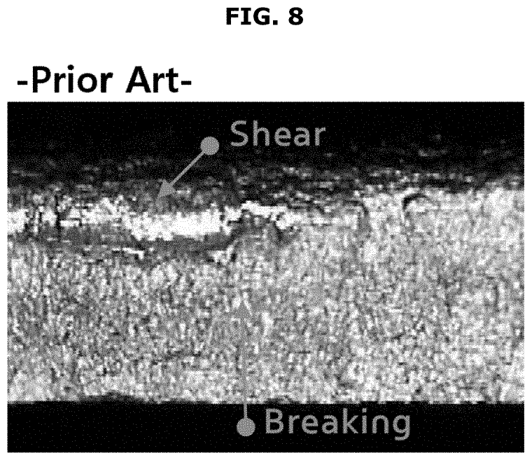

FIG. 8 is a photograph showing a sheared surface of an aluminum material when a conventional trimming process is employed.

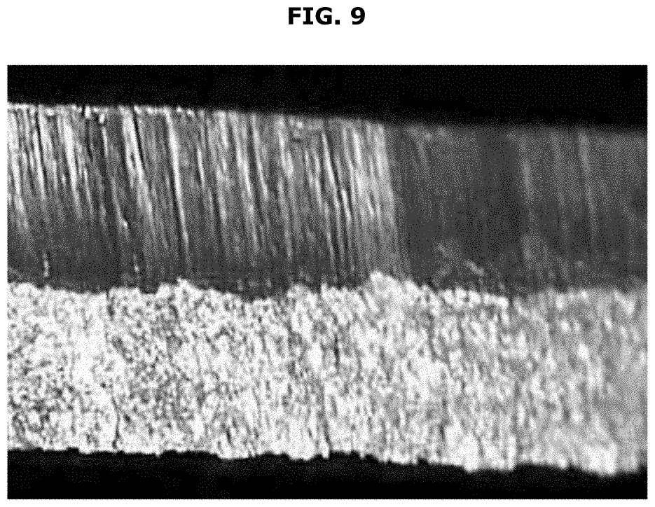

Referring to FIGS. 8 and 9, it can be seen that the shear zone of the sheared surface of the aluminum sheet employing the shearing method according to the present disclosure is increased as compared with that employing the conventional trimming process. Accordingly, the generation of chips of the aluminum material during the shearing process may be suppressed without adding a separate process.

As described above, the present disclosure provides the shearing device for heating a material provided in the existing trimming dies and applying current to the material at a moment of shearing without adding a separate process, and an aluminum material shearing method using the same.

While this present disclosure has been described in connection with what is presently considered to be practical exemplary forms, it is to be understood that the present disclosure is not limited to the disclosed forms, but, on the contrary, it is intended to cover various modifications and equivalent arrangements included within the spirit and scope of the present disclosure.

What is claimed is:

1. A shearing device for an aluminum material, the shearing device comprising:
an upper pad die;
a lower pad die;
a first electrode provided on at least one of the upper pad die and the lower pad die;
a heating device provided on at least one of a first portion of the upper pad die and the lower pad die; and
a shearing die provided on the upper pad die to move up and down with respect to a surface to which the aluminum material is discharged, and including a second electrode.

2. The shearing device of claim 1, further comprising:
a power control device configured to supply the first electrode and the second electrode with direct current when the shearing die comes into contact with the aluminum material; and
a power supply device configured to supply the heating device or the power control device with alternating current.

3. The shearing device of claim 1, wherein the first electrode and the second electrode are provided to have polarities opposite to each other.

4. The shearing device of claim 1, wherein the first electrode and the second electrode are coated with insulators.

5. The shearing device of claim 1, further comprising a cooling channel provided inside the upper pad die and the lower pad die, respectively.

6. The shearing device of claim 5, further comprising a cooling compressor configured to supply the cooling channel with a refrigerant.

7. The shearing device of claim 1, wherein the first portion of each of the upper pad die and the lower pad die are formed of cemented carbide-M series including cemented carbide-M series(WC+TiC+TaC+Co alloys).

8. A shearing method for an aluminum panel comprising steps of:
lowering an upper pad die for a first period of time;
heating the aluminum panel for a second period of time;
supplying current while lowering a shearing die to remove undesired portions of the aluminum panel for a third period of time; and
lifting the shearing die for a fourth period of time.

9. The shearing method of claim 8, wherein the aluminum panel has a temperature in a range of 200° C. to 300° C.

10. The shearing method of claim 8, wherein the second period of time is equal to or greater than eight seconds.

11. The shearing method of claim 8, wherein current density of the supplied current is in a range of 70 A/mm² to 90 A/mm².

12. The shearing method of claim 8, wherein the third period of time is in a range of 0.5 seconds to 0.8 seconds.
